(19) United States
(12) Patent Application Publication
(10) Pub. No.: US 2025/0354352 A1
(43) Pub. Date: Nov. 20, 2025

(54) BOOM ENERGY AND SWING ENERGY RECOVERY SYSTEM FOR MOBILE-LINKED CONSTRUCTION MACHINERY

(71) Applicant: READI ROBUST MACHINE CO., LTD., Busan (KR)

(72) Inventor: Tae Rang JUNG, Gyeongsangnam-do (KR)

(21) Appl. No.: 18/869,641

(22) PCT Filed: May 25, 2023
(86) PCT No.: PCT/KR2023/007211

§ 371 Date: Nov. 26, 2024

(30) Foreign Application Priority Data
May 27, 2022 (KR) 10-2022-0065456
May 24, 2023 (KR) 10-2023-0067000

(51) Int. Cl. E02F 9/22

(52) U.S. Cl. CPC E02F 9/2217

(57) ABSTRACT

The present disclosure relates to a boom energy and swing energy recovery system for mobile-linked construction machinery, and more particularly, to a boom energy and swing energy recovery system for mobile-linked construction machinery, which is controllable in conjunction with a mobile device. According to the present disclosure, the boom energy and swing energy recovery system is able to recover and utilize energy wasted in the event of boom-down and energy wasted in the event of body swing by including a boom energy recovery unit and a swing energy recovery unit, to operate in various modes of operation, and to be easily installed in or detached from existing construction machinery.

### TECHNICAL FIELD

The present disclosure relates to a boom energy and swing energy recovery system for mobile-linked construction machinery, and more particularly, to a boom energy and swing energy recovery system for mobile-linked construction machinery, which is capable of being controlled in conjunction with a mobile device and of recovering boom energy generated during boom-down of a boom and swing energy generated during swing of a construction machine body.

### BACKGROUND ART

Forklifts or excavators are construction machines that are typically used for digging into or cutting the ground, and are widely used in construction sites and various industrial sites. These forklifts may each include a boom having an end movable along a curved trajectory, and the end of the boom may be equipped with different tools including buckets.

The boom is connected with a hydraulic cylinder, and the hydraulic cylinder drives the boom while moving up and down. The hydraulic cylinder is moved up and down by means of the flow of oil in hydraulic systems. The forklift includes a power means such as an engine. The engine may provide force for the flow of oil in hydraulic systems and at the same time provide power for the movement of the forklift.

Typically, the forklift consumes a lot of fuel when moving because it is very heavy. In addition, a lot of fuel is consumed to drive the boom because the dead weight of the boom is large.

With the recent emergence of green issues, various technologies are developed and researched to improve fuel efficiency in the field of construction machinery such as forklifts. For example, a technology or the like has been proposed to assist in the movement of a forklift or the actuation of a boom by recovering boom energy (e.g., potential energy) and then temporarily storing it when the boom of the forklift is moved down.

However, these conventional technologies may reduce work efficiency due to great restrictions on the working operation or working speed of the boom or the like, and may be very difficult to install on a variety of existing forklifts.

Meanwhile, various types of construction machinery including forklifts or excavators have a body arranged at the upper portion thereof, wherein the body is equipped with a cabinet for an operator to board, an engine, etc., and performs tasks while swinging horizontally.

In addition to the boom energy generated during the boom-down of a boom, swing energy is also generated during the horizontal swing of a body. However, there has been proposed no technology or method for recovering and storing boom energy and swing energy and reutilizing them so far.

Hence, there is a need for a method to recover and store a vast amount of boom energy and swing energy that is typically lost in construction machinery, and then to utilize it.

Meanwhile, various types of construction machinery display and provide information through the display therein, which allows an operator to work while recognizing the current status of the construction machinery.

Various methods have been proposed to link construction machinery with mobile devices in recent years, but they may result in deterioration in linkage and thus versatility because the status of the construction machinery, etc. are simply provided to the mobile devices and recognized by operators.

### PRIOR ART LITERATURE

### Patent Document

(Patent Document 1) Korean Patent No. 10-2309862

### DISCLOSURE

### Technical Problem

The present disclosure has been made in view of the technical background as described above, and is directed to use for construction machinery. An object of the present disclosure is to provide a boom energy and swing energy recovery system for mobile-linked construction machinery, which is capable of being controlled in conjunction with a mobile device, of recovering and utilizing swing energy wasted during swing of a body together with boom energy wasted during boom-down of a boom, of operating in various modes of operation, and of being easily installed in or detached from existing construction machinery.

### Technical Solution

In accordance with an aspect of the present disclosure, there is provided a boom energy and swing energy recovery system for mobile-linked construction machinery, which is installed in a construction machine to recover energy, wherein the construction machine includes a boom cylinder including a rod raised and lowered by means of a flow of oil, a large chamber, and a small chamber formed on the large chamber, an engine configured to provide the flow of oil to the boom cylinder and connected at its shaft to a main pump, a boom driven up/down by the boom cylinder by means of the flow of oil, and a body installed on a drive unit of the construction machine to swing horizontally by driving of a swing motor. The boom energy and swing energy recovery system includes a main control valve connected to the boom cylinder to selectively control the flow of oil provided to the boom cylinder, a hydraulic motor assembly including a hydraulic motor connected to the engine to generate a rotational force by means of oil introduced thereinto and connected at its rotary shaft to the shaft of the engine for provision of the rotational force, and at least one pipe for inflow and outflow of oil therethrough, a boom energy recovery unit configured to recover oil wasted during boom-down by the boom cylinder, a swing energy recovery unit configured to recover oil wasted during swing of the body, a mobile device held by a user, and a controller linked to the mobile device and configured to control an operation of the construction machine based on an operation signal, wherein boom energy generated by means of the oil recovered by the boom energy recovery unit and swing energy generated by means of the oil recovered by the swing energy recovery unit are reused.

The main control valve may include a spool operated to allow oil to flow toward the large chamber or the small chamber in the boom cylinder, a main valve line through which oil flows to the main control valve, a boom-up valve line connected to the spool and in which a boom-up valve is placed, the boom-up valve being opened so that oil flows to the large chamber by movement of the spool to allow the boom to be moved up, and a boom-down valve line connected to the spool and in which a boom-down valve is placed, the boom-down valve being opened so that oil flows to the small chamber by movement of the spool to allow the boom to be moved down.

The boom energy recovery unit may include an accumulator connected to the boom cylinder to accumulate oil introduced from the boom cylinder and to discharge the accumulated oil to the boom cylinder and the engine, a boom energy valve assembly including a plurality of lines for oil to flow therethrough and at least one valve installed in a selected one of the plurality of lines to control a flow rate of oil, and at least one oil tank provided to store oil introduced thereinto or discharge the stored oil therefrom.

The boom energy valve assembly may further include a first line having one side connected to the large chamber in the boom cylinder, a second line connecting the first line and the accumulator, a third line connecting the first line and the accumulator, a fourth line connecting the accumulator and the hydraulic motor assembly, a fifth line having one side connected to the small chamber in the boom cylinder, a sixth line branched from the first line and connected to the fifth line, a seventh line branched from the first line, and an eighth line having one side connected to the fifth line and the sixth line. The boom energy valve assembly may further include a first AC valve placed in the second line to control the flow rate of oil to allow oil to flow only toward the accumulator, a CA valve placed in the third line to control the flow rate of oil to allow oil to flow only toward the first line, a first CM valve placed in the fourth line to control the flow rate of oil, an AB valve placed in the sixth line to control the flow rate of oil, an AR valve placed in the seventh line to control the flow rate of oil, a first release valve placed on a passage between the accumulator and the oil tank and operated in an on/off manner, and a first solenoid valve placed in parallel to the first release valve between the accumulator and the oil tank.

The controller may control the boom energy recovery unit to be operated, based on the operation signal, in any one selected from a boom energy recovery mode in which oil in the event of boom-down of the boom is recovered to the accumulator for storage, a boom energy eco mode in which an output of the engine is assisted by means of the oil accumulated in the accumulator, a boom energy power mode in which the oil accumulated in the accumulator is used to assist the power required for boom-up motion, a boom energy pressure release mode in which the oil accumulated in the accumulator is discharged to the outside to release a pressure within the accumulator, and a boom-energy-recovery-off mode in which accumulation is temporarily stopped when the boom touches the ground.

In the boom energy recovery mode, when the boom is moved down, after the boom-down valve is closed, oil may flow into the small chamber in the boom cylinder to lower the rod of the boom cylinder, the oil within the large chamber may be discharged through the first line, the oil flowing in the first line may be recovered to the accumulator through the second line, and the oil recovered to the accumulator may be accumulated, stored, and then utilized.

In addition, in the boom energy recovery mode, the AB valve may be opened to introduce some of the oil flowing in the first line into the small chamber in the boom cylinder through the sixth line and the fifth line so as to increase a boom-down speed of the boom.

Furthermore, in the boom energy recovery mode, the AR valve may be opened to introduce some of the oil flowing in the first line into the oil tank through the seventh line.

In the boom energy eco mode, when the boom is moved up, the first CM valve placed in the fourth line may be opened, the CA valve placed in the third line may be closed, the oil accumulated in the accumulator may flow into the hydraulic motor of the hydraulic motor assembly through the fourth line, the rotary shaft of the hydraulic motor may be rotated by means of the oil introduced thereinto, and the rotational force of the rotary shaft of the hydraulic motor may be provided to the shaft of the engine to assist the output of the shaft of the engine.

In the boom energy power mode, when the boom is moved up, the CA valve placed in the third line may be opened, the first CM valve placed in the fourth line may be closed, the oil accumulated in the accumulator may flow into the large chamber in the boom cylinder through the third line and the first line, and the boom may have an increased boom-up speed by introducing oil from the accumulator to the large chamber to increase an amount of oil introduced into the large chamber, in addition to the inflow of oil to the large chamber by the engine.

In the boom energy pressure release mode, the first release valve may be opened, the CA valve and the first CM valve may be closed, and some of the oil accumulated in the accumulator may be discharged to the oil tank through the first release valve to reduce the pressure within the accumulator.

In addition, in the boom energy pressure release mode, the first solenoid valve may be opened, the CA valve and the first CM valve may be closed, and all of the oil accumulated in the accumulator may be discharged to the oil tank through the first solenoid valve to reduce the pressure within the accumulator.

In the boom-energy-recovery-off mode, when the boom touches the ground, the first AC valve may be closed to temporarily stop accumulation of oil in the accumulator.

In addition, in the boom-energy-recovery-off mode, when the boom touches the ground, the first AC valve and the AR valve may be closed, and the AB valve may be opened to introduce oil discharged from the large chamber only into the small chamber.

The swing energy recovery unit may include a high-pressure accumulator connected to a swing motor connected to the main pump of the engine to accumulate oil introduced along with rotation of the swing motor and to discharge the accumulated oil to the hydraulic motor assembly, a low-pressure accumulator connected to the swing motor connected to the main pump of the engine to provide oil to the swing motor, thereby preventing cavitation of the swing motor, a swing energy valve assembly including a plurality of lines for oil to flow therethrough and at least one valve installed in a selected one of the plurality of lines to control a flow rate of oil, and at least one oil tank provided to store oil introduced thereinto or discharge the stored oil therefrom.

The swing energy valve assembly may further include an eleventh line having one side connected to the main pump, a twelfth line connected to the other side of the eleventh line and connected to the left side of the swing motor, a thirteenth line connected to the other side of the eleventh line and connected to the right side of the swing motor, a fourteenth line branched from the twelfth line, a fifteenth line branched from the thirteenth line, a sixteenth line merging the fourteenth line and the fifteenth line and connected to the high-pressure accumulator, a seventeenth line connecting the high-pressure accumulator and the hydraulic motor, and an eighteenth line branched from the seventeenth line and connected to the oil tank. The swing energy valve assembly may further include a direction switching valve placed at a connection point between the eleventh line and the twelfth and thirteenth lines to control a direction of flow of oil, a second AC valve placed in the sixteenth line to control the flow rate of oil to allow oil to flow only toward the high-pressure accumulator, a second CM valve placed in the seventeenth line to control the flow rate of oil, first and second check valves arranged in the fourteenth line and the fifteenth line to control the flow rate of oil, a second release valve placed between the high-pressure accumulator and the oil tank in the eighteenth line and operated in an on/off manner, and a second solenoid valve placed in parallel to the second release valve between the high-pressure accumulator and the oil tank in the eighteenth line.

The controller may control the swing energy recovery unit to be operated, based on the operation signal, in any one selected from a swing energy recovery mode in which oil in the event of swing of the body is recovered to and then stored in the high-pressure accumulator, a swing energy eco mode in which an output of the engine is assisted by means of the oil accumulated in the high-pressure accumulator, and a swing energy pressure release mode in which the oil accumulated in the high-pressure accumulator is discharged to the outside to release a pressure within the high-pressure accumulator.

In the swing energy recovery mode, when the body swings, oil may flow into the eleventh line from the main pump, the direction switching valve may be controlled to switch the direction of flow of oil to the twelfth line or the thirteenth line for inflow of oil, the oil flowing into the twelfth line or the thirteenth line may allow the swing motor to be rotated in a right or left direction, and then flow into the fourteenth line or the fifteenth line through the thirteenth line or the twelfth line, the oil flowing into the fourteenth line or the fifteenth line may be recovered to the high-pressure accumulator through the sixteenth line, and the oil recovered to the high-pressure accumulator may be accumulated, stored, and then utilized.

In the swing energy eco mode, when the body swings, the second CM valve placed in the seventeenth line may be opened, the oil accumulated in the high-pressure accumulator may flow into the hydraulic motor of the hydraulic motor assembly through the seventeenth line, the rotary shaft of the hydraulic motor may be rotated by means of the oil introduced thereinto, and the rotational force of the rotary shaft may be provided to the shaft of the engine to assist the output of the shaft of the engine.

In the swing energy pressure release mode, the second release valve may be opened to discharge some of the oil accumulated in the high-pressure accumulator to the oil tank through the second release valve, thereby reducing the pressure within the high-pressure accumulator.

In addition, in the swing energy pressure release mode, the second solenoid valve may be opened to discharge all of the oil accumulated in the high-pressure accumulator to the oil tank through the second solenoid valve, thereby reducing the pressure within the high-pressure accumulator.

The swing energy valve assembly may further include a twenty-first line connecting the twelfth line and the thirteenth line, and a twenty-second line branched from the twenty-first line and connected to the oil tank. The swing energy valve assembly may further include first and second relief valves spaced at regular intervals from each other in the twenty-first line and opened by the pressure of oil to control the flow rate of oil, and a fifth check valve placed in the twenty-second line to control the flow rate of oil.

When the pressure of the oil flowing into the twelfth line or the thirteenth line through the eleventh line during swing acceleration of the body exceeds a preset oil pressure range, the controller may cause the first relief valve or the second relief valve to be opened, some of the oil introduced into the swing motor through the twelfth line or the thirteenth line to flow into the twenty-second line through the twenty-first line and the first relief valve or the twenty-first line and the second relief valve, and the fifth check valve to be opened to introduce some of the oil flowing into the twenty-second line into the oil tank.

The swing energy valve assembly may further include a twenty-third line connecting the twelfth line and the thirteenth line, and a twenty-fourth line branched from the twenty-third line and connected to the low-pressure accumulator. The swing energy valve assembly may further include third and fourth check valves spaced at regular intervals from each other in the twenty-third line and configured to control the flow rate of oil.

When the swing of the body is decelerated, the controller may cause the oil that flows into the swing motor through the twelfth line or the thirteenth line to rotate the swing motor and then flows into the high-pressure accumulator to be replaced, so that after the third or fourth check valve is opened, the oil in the low-pressure accumulator flows into the twenty-third line through the twenty-fourth line and the third or fourth check valve, and the oil flowing into the twenty-third line to be introduced into the swing motor through the twelfth line or the thirteenth line, thereby preventing the cavitation of the swing motor.

### Advantageous Effects

According to the present disclosure, a boom energy and swing energy recovery system for mobile-linked construction machinery has an effect in that it is able to be controlled in conjunction with a mobile device, to recover boom energy wasted during boom-down of a boom, to recover and utilize swing energy of a body while preventing cavitation that may occur during deceleration of the body, together with assisting an engine operation with the swing energy generated during acceleration of the body, to operate in various modes of operation, and to be easily installed in or detached from existing construction machinery.

### BRIEF DESCRIPTION OF DRAWINGS

FIG. 1 is a conceptual view illustrating an overall appearance of a construction machine according to an embodiment of the present disclosure.

FIG. 2 is a schematic diagram illustrating a boom energy and swing energy recovery system for mobile-linked construction machinery according to an embodiment of the present disclosure.

FIG. 3 is a perspective view illustrating a hydraulic motor assembly according to the embodiment of the present disclosure.

FIG. 4 is a top view illustrating a boom energy recovery unit according to the embodiment of the present disclosure.

FIG. 5 is a perspective view illustrating the boom energy recovery unit according to the embodiment of the present disclosure.

FIG. 6 is a top view illustrating a bracket cut out from the boom energy recovery unit according to the embodiment of the present disclosure.

FIG. 7 is a schematic diagram illustrating a boom energy recovery mode in which boom energy is recovered in the boom energy and swing energy recovery system for mobile-linked construction machinery according to the embodiment of the present disclosure.

FIG. 8 is a schematic diagram illustrating a boom energy eco mode in which an engine output is assisted by recovered boom energy in the boom energy and swing energy recovery system for mobile-linked construction machinery according to the embodiment of the present disclosure.

FIG. 9 is a schematic diagram illustrating a boom energy power mode in which power required for boom-up motion of a boom is assisted by recovered boom energy in the boom energy and swing energy recovery system for mobile-linked construction machinery according to the embodiment of the present disclosure.

FIG. 10 is a schematic diagram illustrating a boom energy pressure release mode in which an internal pressure of an accumulator is released in the boom energy and swing energy recovery system for mobile-linked construction machinery according to the embodiment of the present disclosure.

FIG. 11 is a schematic diagram illustrating a swing energy recovery mode in which swing energy is recovered when a body swings to the right in the boom energy and swing energy recovery system for mobile-linked construction machinery according to the embodiment of the present disclosure.

FIG. 12 is a schematic diagram illustrating a swing energy recovery mode in which swing energy is recovered when the body swings to the left in the boom energy and swing energy recovery system for mobile-linked construction machinery according to the embodiment of the present disclosure.

FIG. 13 is a schematic diagram illustrating a swing energy eco mode in which an engine output is assisted by recovered swing energy in the boom energy and swing energy recovery system for mobile-linked construction machinery according to the embodiment of the present disclosure.

FIG. 14 is a schematic diagram illustrating a swing energy pressure release mode in which an internal pressure of a high-pressure accumulator is released in the boom energy and swing energy recovery system for mobile-linked construction machinery according to the embodiment of the present disclosure.

FIG. 15 is a schematic diagram illustrating a flow path of oil during acceleration of the body in the boom energy and swing energy recovery system for mobile-linked construction machinery according to the embodiment of the present disclosure.

FIG. 16 is a schematic diagram illustrating a flow path of oil during deceleration of the body in the boom energy and swing energy recovery system for mobile-linked construction machinery according to the embodiment of the present disclosure.

### LIST OF REFERENCE NUMERALS

100: construction machine
110: body
120: engine
121: shaft
122: main pump
123: auxiliary pump
130: boom
140: boom cylinder
141: rod
142: large chamber
143: small chamber
144: large chamber line
145: small chamber line
150: cabinet
151: joystick
160: main control valve
161: spool
162: main valve line
163: boom-up valve
164: boom-down valve
165: boom-up valve line
166: boom-down valve line
170: controller
200: boom energy recovery unit
210: bracket
211: mount
212: hollow
213: groove
220: accumulator
230: boom energy valve assembly
240: main pipe
241: joint block
250: pilot pipe
300: hydraulic motor assembly
310: hydraulic motor
400: mobile device
500: swing energy recovery unit
501: swing motor
503a, 503b: direction switching joystick
510: high-pressure accumulator
520: low-pressure accumulator
530: swing energy valve assembly
531: first check valve
532: second check valve
533: third check valve
534: fourth check valve
535: fifth check valve
537: first relief valve
538: second relief valve
539: direction switching valve
CA: CA valve
CM1: first CM valve
CM2: second CM valve
AC1: first AC valve
AC2: second AC valve
AB: AB valve
AR: AR valve
RE1: first release valve
RE2: second release valve
SOL1: first solenoid valve
SOL2: second solenoid valve
L1: first line
L2: second line
L3: third line
L4: fourth line
L5: fifth line
L6: sixth line
L7: seventh line
L8: eighth line
L11: eleventh line
L12: twelfth line
L13: thirteenth line
L14: fourteenth line
L15: fifteenth line
L16: sixteenth line
L17: seventeenth line
L21: twenty-first line
L22: twenty-second line
L23: twenty-third line
L24: twenty-fourth line
S1: first sensor
S2: second sensor
S3: third sensor
S4: fourth sensor
S5: fifth sensor
S6: sixth sensor
S7: seventh sensor
S8: eighth sensor
T: oil tank
T1: first oil tank
T2: second oil tank
T3: third oil tank
T4: fourth oil tank
T5: fifth oil tank
T6: sixth oil tank

### BEST MODE

The present disclosure provides a boom energy and swing energy recovery system for mobile-linked construction machinery, which is installed in a construction machine to recover energy, wherein the construction machine includes a boom cylinder including a rod raised and lowered by means of a flow of oil, a large chamber, and a small chamber formed on the large chamber, an engine configured to provide the flow of oil to the boom cylinder and connected at its shaft to a main pump, a boom driven up/down by the boom cylinder by means of the flow of oil, and a body installed on a drive unit of the construction machine to swing horizontally by driving of a swing motor. The boom energy and swing energy recovery system includes a main control valve connected to the boom cylinder to selectively control the flow of oil provided to the boom cylinder, a hydraulic motor assembly including a hydraulic motor connected to the engine to generate a rotational force by means of oil introduced thereinto and connected at its rotary shaft to the shaft of the engine for provision of the rotational force, and at least one pipe for inflow and outflow of oil therethrough, a boom energy recovery unit configured to recover oil wasted during boom-down by the boom cylinder, a swing energy recovery unit configured to recover oil wasted during swing of the body, a mobile device held by a user, and a controller linked to the mobile device and configured to control an operation of the construction machine based on an operation signal, wherein boom energy generated by means of the oil recovered by the boom energy recovery unit and swing energy generated by means of the oil recovered by the swing energy recovery unit are reused.

### Mode for Disclosure

Various modifications and different embodiments will be described below in detail with reference to the accompanying drawings so that those skilled in the art can easily carry out the disclosure. It should be understood, however, that the present disclosure is not intended to be limited to the specific embodiments, but the present disclosure includes all modifications, equivalents or replacements that fall within the spirit and scope of the disclosure as defined in the following claims.

The terminology used herein is for the purpose of describing specific embodiments only and is not intended to limit the scope of the disclosure. As used herein, the singular forms “a”, “an” and “the” are intended to include the plural forms as well, unless the context clearly indicates otherwise.

In the disclosure, terms such as “comprises”, “includes”, or “have/has” should be construed as designating that there are such features, integers, steps, operations, components, parts, and/or combinations thereof, not to exclude the presence or possibility of adding of one or more of other features, integers, steps, operations, components, parts, and/or combinations thereof. Reference will now be made in detail to exemplary embodiments of the present disclosure, examples of which are illustrated in the accompanying drawings. It should be noted that like reference numerals refer to like parts throughout various drawings and exemplary embodiments.

In certain embodiments, a detailed description of functions and configurations well known in the art may be omitted to avoid obscuring appreciation of the disclosure by those skilled in the art. For the same reason, some components may be exaggerated, omitted, or schematically illustrated in the accompanying drawings.

Hereinafter, a boom energy and swing energy recovery system for mobile-linked construction machinery and a construction machine including the same according to the present disclosure will be described in detail with reference to the accompanying drawings.

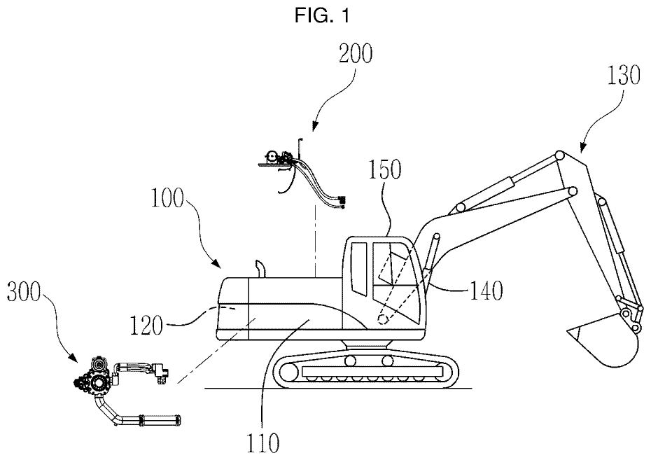

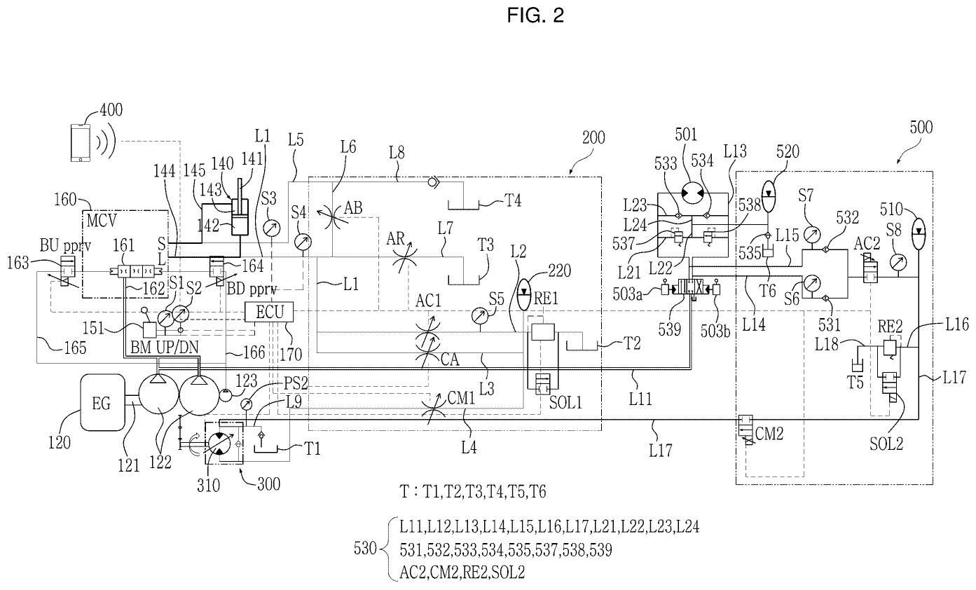

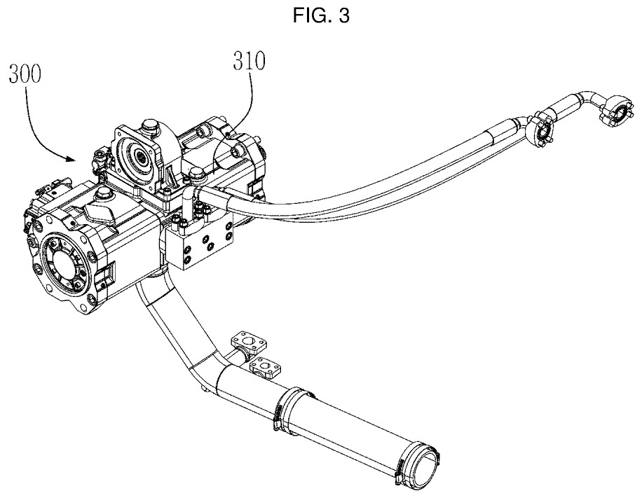

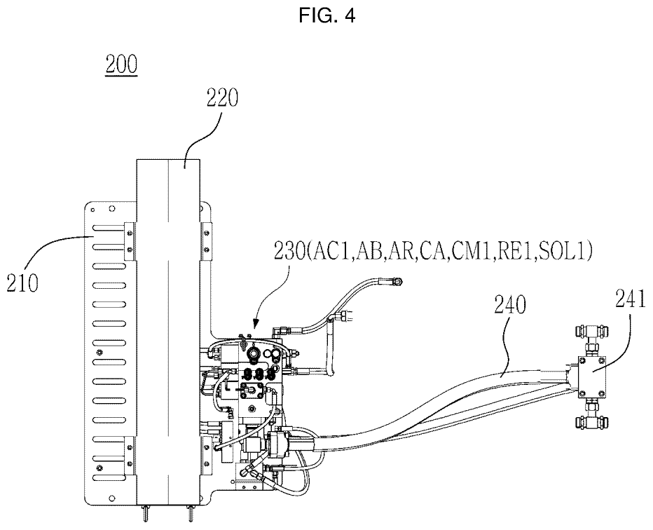

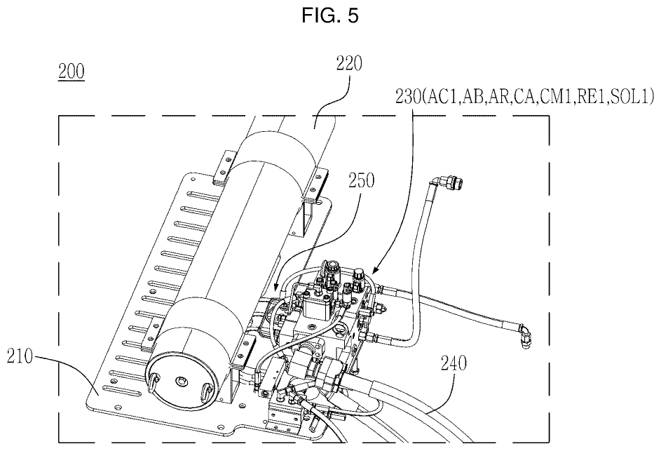

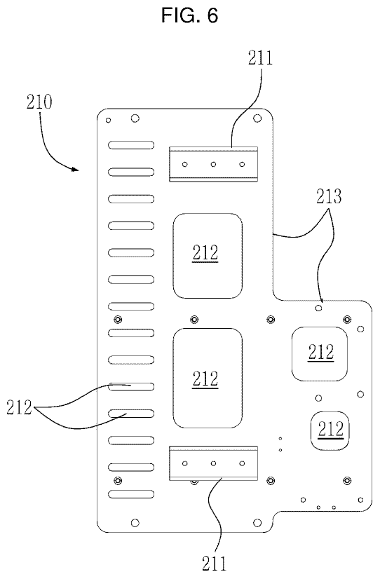

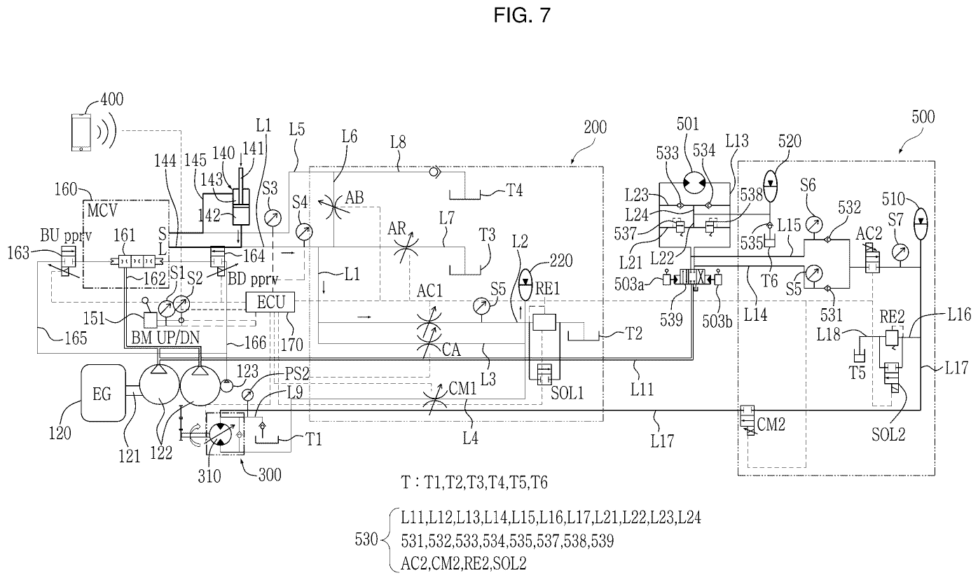

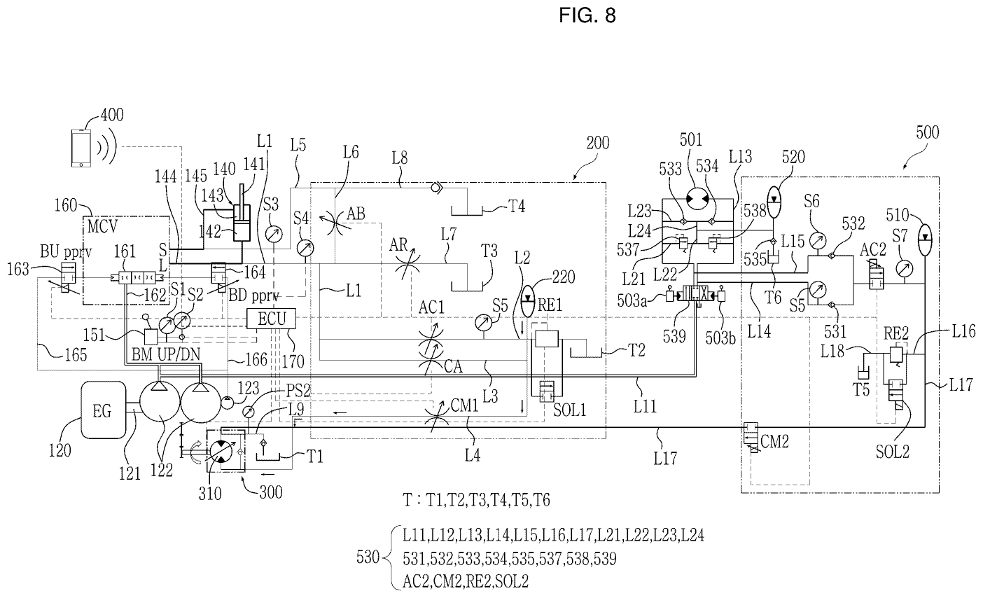

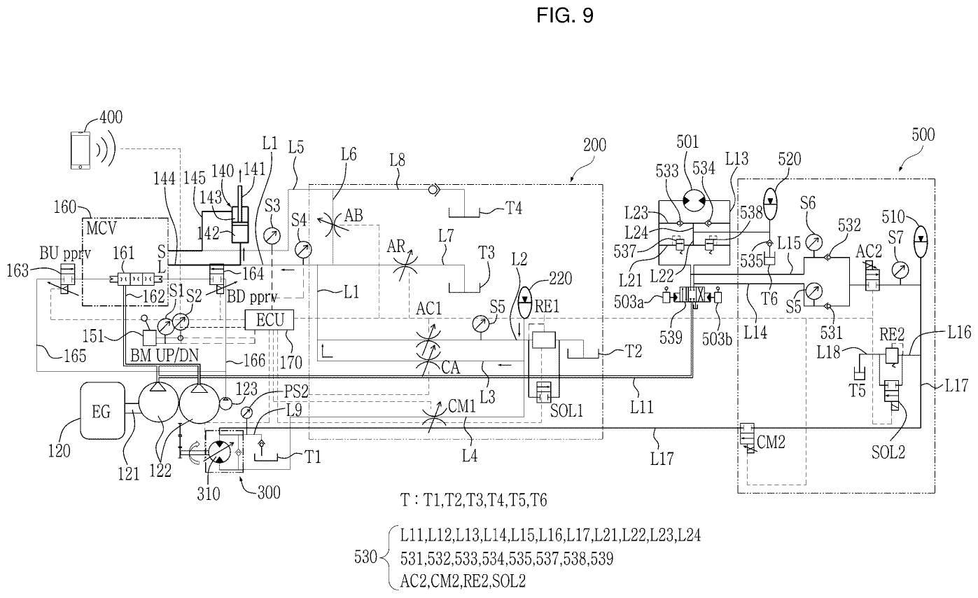

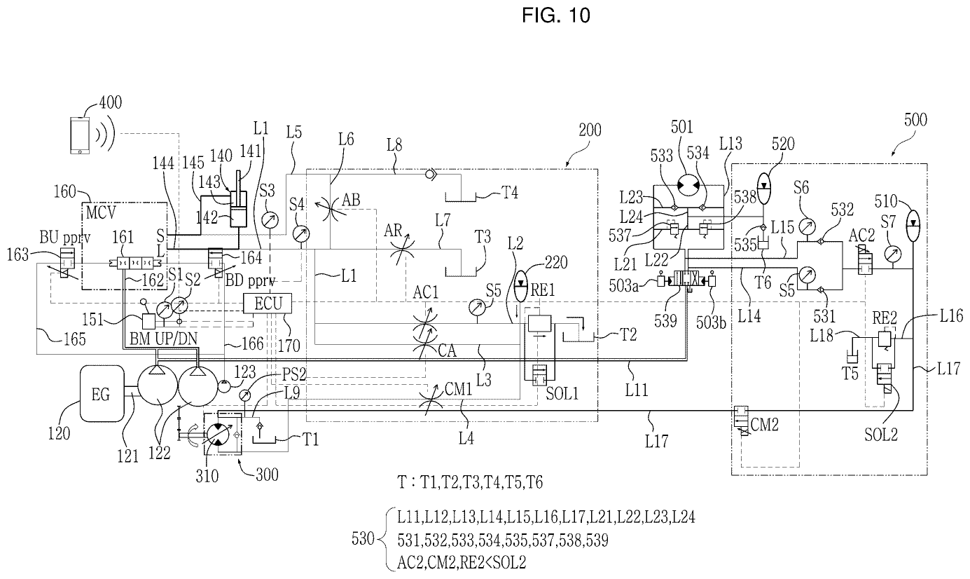

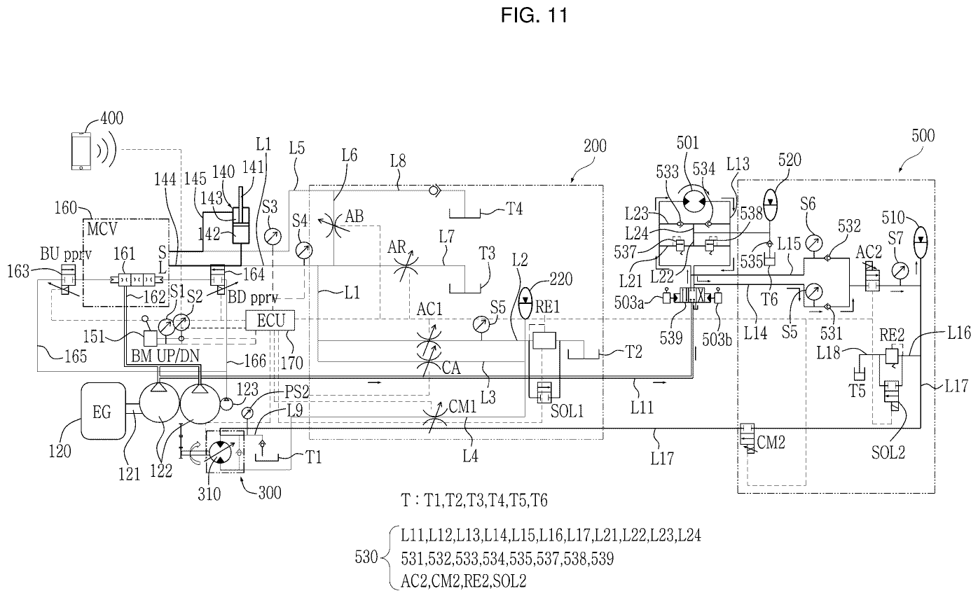

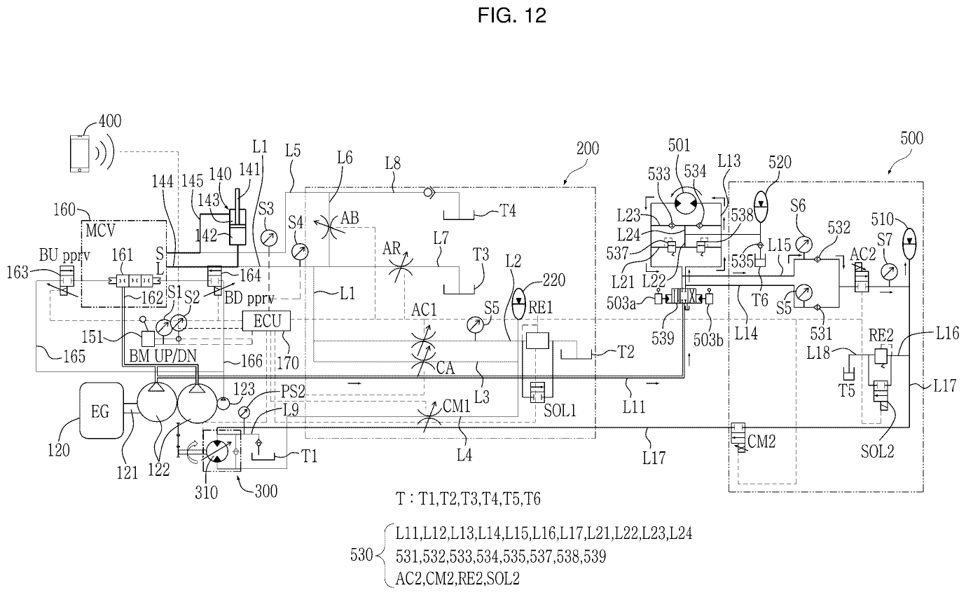

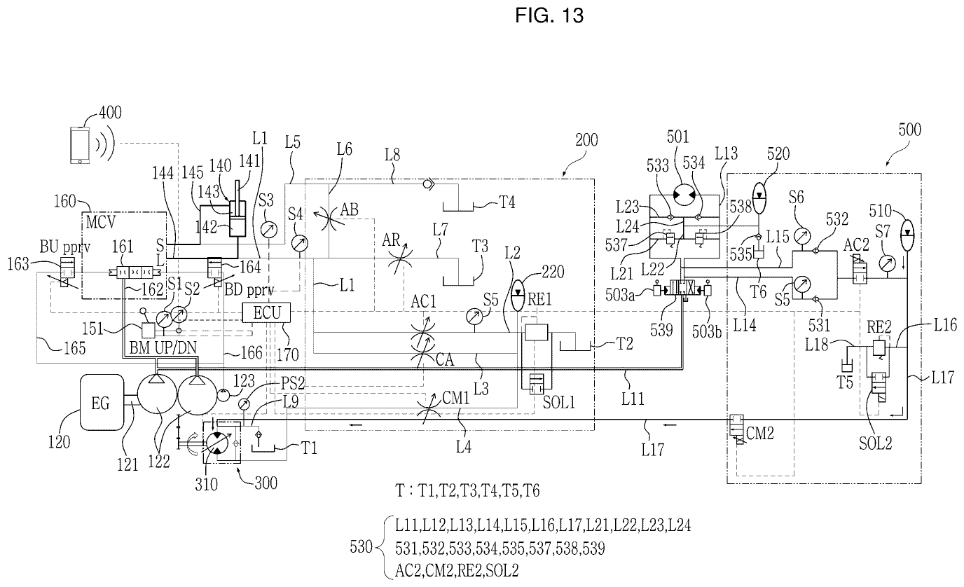

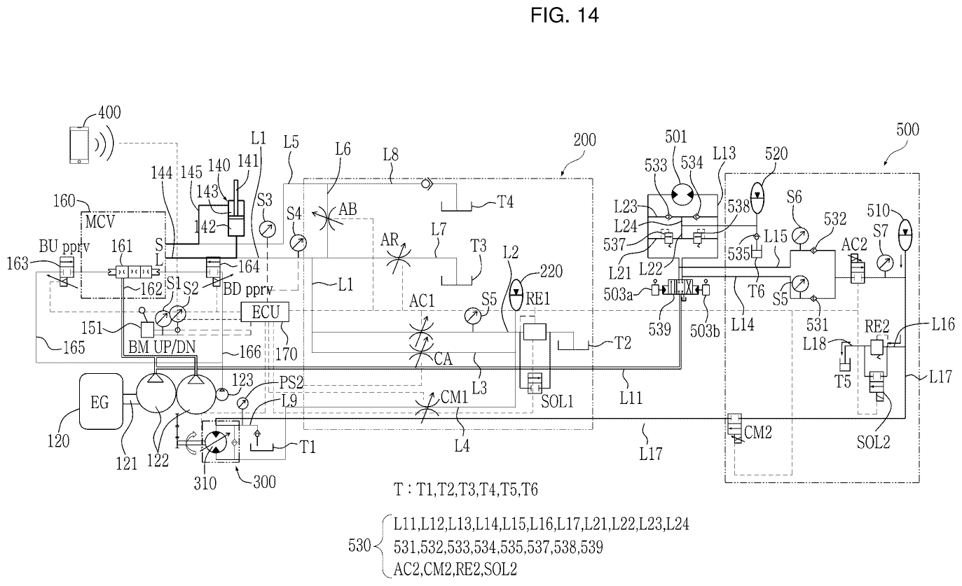

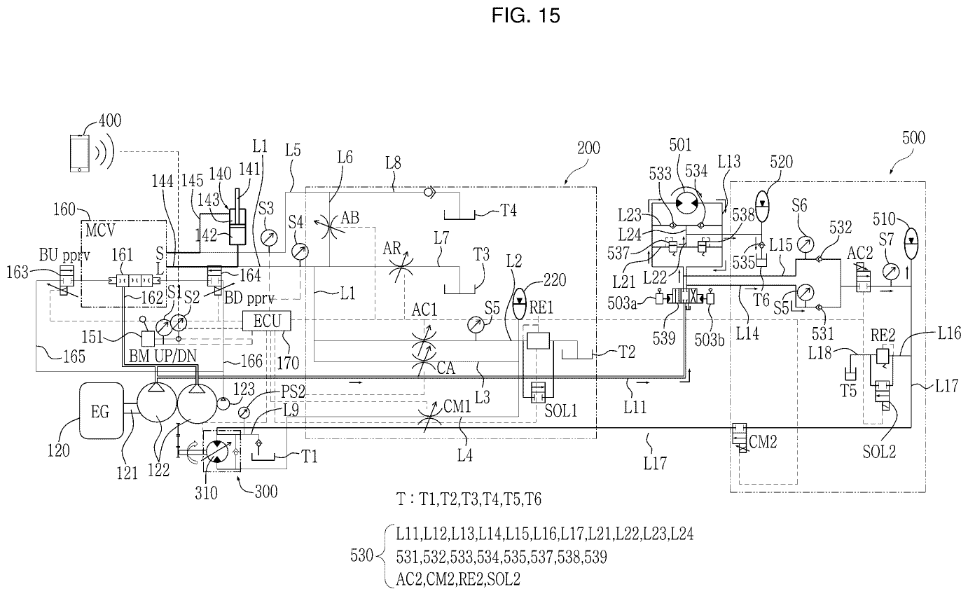

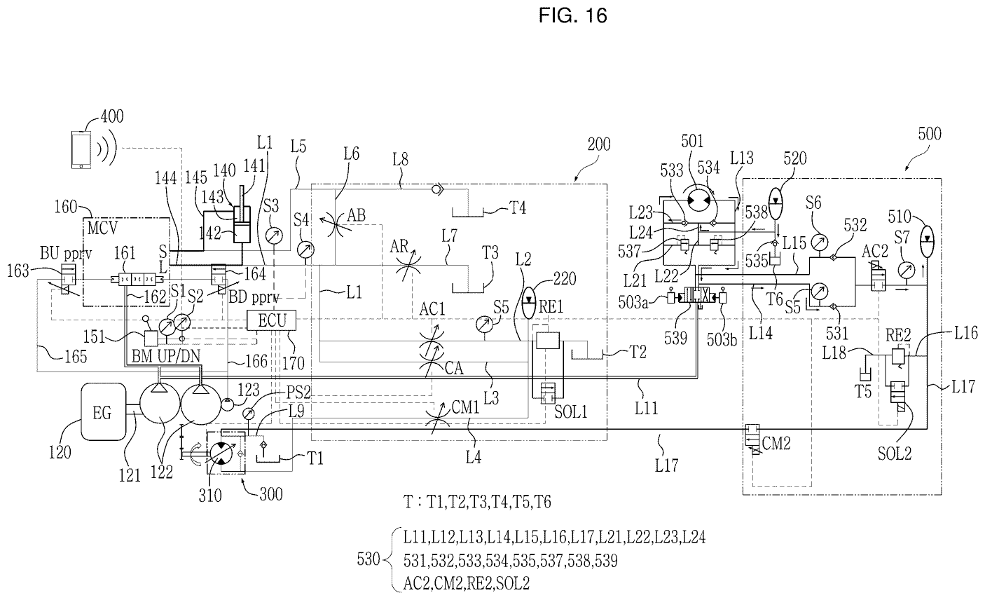

FIG. 1 is a conceptual view illustrating an overall appearance of a construction machine according to an embodiment of the present disclosure. FIG. 2 is a schematic diagram illustrating a boom energy and swing energy recovery system for mobile-linked construction machinery according to an embodiment of the present disclosure. FIG. 3 is a perspective view illustrating a hydraulic motor assembly according to the embodiment of the present disclosure. FIG. 4 is a top view illustrating a boom energy recovery unit according to the embodiment of the present disclosure. FIG. 5 is a perspective view illustrating the boom energy recovery unit according to the embodiment of the present disclosure. FIG. 6 is a top view illustrating a bracket cut out from the boom energy recovery unit according to the embodiment of the present disclosure. FIG. 7 is a schematic diagram illustrating a boom energy recovery mode in which boom energy is recovered in the boom energy and swing energy recovery system for mobile-linked construction machinery according to the embodiment of the present disclosure. FIG. 8 is a schematic diagram illustrating a boom energy eco mode in which an engine output is assisted by recovered boom energy in the boom energy and swing energy recovery system for mobile-linked construction machinery according to the embodiment of the present disclosure. FIG. 9 is a schematic diagram illustrating a boom energy power mode in which power required for boom-up motion of a boom is assisted by recovered boom energy in the boom energy and swing energy recovery system for mobile-linked construction machinery according to the embodiment of the present disclosure. FIG. 10 is a schematic diagram illustrating a boom energy pressure release mode in which an internal pressure of an accumulator is released in the boom energy and swing energy recovery system for mobile-linked construction machinery according to the embodiment of the present disclosure. FIG. 11 is a schematic diagram illustrating a swing energy recovery mode in which swing energy is recovered when a body swings to the right in the boom energy and swing energy recovery system for mobile-linked construction machinery according to the embodiment of the present disclosure. FIG. 12 is a schematic diagram illustrating a swing energy recovery mode in which swing energy is recovered when the body swings to the left in the boom energy and swing energy recovery system for mobile-linked construction machinery according to the embodiment of the present disclosure. FIG. 13 is a schematic diagram illustrating a swing energy eco mode in which an engine output is assisted by recovered swing energy in the boom energy and swing energy recovery system for mobile-linked construction machinery according to the embodiment of the present disclosure. FIG. 14 is a schematic diagram illustrating a swing energy pressure release mode in which an internal pressure of a high-pressure accumulator is released in the boom energy and swing energy recovery system for mobile-linked construction machinery according to the embodiment of the present disclosure. FIG. 15 is a schematic diagram illustrating a flow path of oil during acceleration of the body in the boom energy and swing energy recovery system for mobile-linked construction machinery according to the embodiment of the present disclosure. FIG. 16 is a schematic diagram illustrating a flow path of oil during deceleration of the body in the boom energy and swing energy recovery system for mobile-linked construction machinery according to the embodiment of the present disclosure.

The boom energy and swing energy recovery system for mobile-linked construction machinery according to the embodiment of the present disclosure will be described below in detail with reference to FIGS. 1 to 6.

The boom energy and swing energy recovery system for mobile-linked construction machinery according to the embodiment of the present disclosure has a structure that may be installed in and detached from a construction machine 100, and may include a main control valve 160, a hydraulic motor assembly 300, a boom energy recovery unit 200, a swing energy recovery unit 500, a mobile device 400, and a controller 170. The boom energy and swing energy recovery system may be installed in connection with a boom cylinder 140, an engine 120, a boom 130, and a body 110 of the construction machine 100.

Specifically, the boom 130 and the boom cylinder 140 may be connected to the body 110. The boom cylinder 140 may be moved up and down by means of the flow of oil, and the boom 130 may be rotated by the upward and downward movement of the boom cylinder 140.

The engine 120 may be placed inside the body 110. The engine 120 may provide the boom cylinder 140 with the flow of oil. The engine 120 may provide a driving force to a drive unit (not shown) placed at the bottom of the body 110.

The operation of the boom cylinder 140 will be discussed in more detail as follows. The construction machine 100 may have a cabinet 150 placed in the body 110 for an operator to board. The cabinet 150 may be provided with a joystick 151 for controlling the boom-up or boom-down motion of the boom 130.

Specifically, the boom cylinder 140 may include a rod 141 that is raised and lowered by means of the flow of oil and connected to the boom 130. The boom cylinder 140 may include a large chamber 142 and a small chamber 143 formed on the large chamber 142.

The rod 141 may be placed between the small chamber 143 and the large chamber 142 in the boom cylinder 140. The rod 141 may be raised when oil enters the large chamber 142, and may be lowered when oil enters the small chamber 143. The boom 130 may be moved up when the rod 141 is raised, and the boom 130 may be moved down when the rod 141 is lowered.

The main control valve 160 may be connected to the boom cylinder 140 to selectively control the flow of oil provided to the boom cylinder 140. The main control valve 160 may be placed on the construction machine 100.

Here, the main control valve 160 may be connected to the large chamber 142 through a large chamber line 144, and the main control valve 160 may be connected to the small chamber 143 through a small chamber line 145.

The main control valve 160 may have a spool 161 placed thereon. The spool 161 enables oil to flow toward the small chamber 143 or toward the large chamber 142. In other words, the rod 141 of the boom cylinder 140 may be raised or lowered by the operation of the spool 161 placed on the main control valve 160.

The engine 120 may be equipped with a shaft 121, which is connected to a main pump 122. The main pump 122 and the spool 161 may be connected to a main valve line 162, and oil may flow to the spool 161 and the main control valve 160 through the main valve line 162.

The spool 161 may be controlled by a boom-up valve 163 and a boom-down valve 164. An auxiliary pump 123 may be connected to the shaft 121 of the engine 120. The auxiliary pump 123 and the spool 161 may be connected to a boom-up valve line 165, and the boom-up valve 163 may be placed in the boom-up valve line 165. The auxiliary pump 123 and the spool 161 may be connected to a boom-down valve line 166, and the boom-down valve 164 may be placed in the boom-down valve line 166. When the boom-up valve 163 is opened, the spool 161 may move so that oil flows to the large chamber 142. When the boom-down valve 164 is opened, the spool 161 may move so that oil flows to the small chamber 143.

The hydraulic motor assembly 300 may be connected to the engine 120 that provides the flow of oil, to provide the engine with a rotational force generated by means of a fluid.

The hydraulic motor assembly 300 has a hydraulic motor 310. The hydraulic motor 310 is a device that generates a rotational force by means of a fluid, and the rotational force may be generated when oil flows into the hydraulic motor 310. The rotary shaft of the hydraulic motor 310 may be connected to the shaft 121 of the engine 120. Accordingly, the hydraulic motor 310 may provide a rotational force to the shaft 121. The hydraulic motor assembly 300 may have a pipe through which oil is introduced into or discharged from the hydraulic motor 310, and may also have a pipe connected to a first oil tank T1 to be described later.

The hydraulic motor 310 of the hydraulic motor assembly 300 may be installed in an engine room where the engine 120 is placed in the construction machine 100. For this purpose, the hydraulic motor 310 may have a fastener (not shown) for fastening to the engine room. Besides, a pipe through which oil may be introduced or discharged, a pipe connected to the first oil tank T1, etc. may be provided for connection to corresponding pipes in existing construction machinery.

The boom energy recovery unit 200 is configured to recover oil wasted during boom-down by the boom cylinder 140. The boom energy recovery unit 200 may be connected to the boom cylinder 140 to discharge accumulated oil to the boom cylinder 140, and the oil in the boom cylinder 140 may be introduced and accumulated. The boom energy recovery unit 200 may be an accumulator assembly capable of accumulating oil in the boom cylinder 140.

Specifically, the boom energy recovery unit 200 may include a bracket 210, an accumulator 220, a boom energy valve assembly 230, a main pipe 240, and an oil tank T.

The bracket 210 is detachably fastened to the body 110 of the construction machine 100, and the accumulator 220, the boom energy valve assembly 230, and the main pipe 240 are arranged on the bracket 210. The bracket 210 is a component installed on the construction machine 100, and on which the accumulator 220, the boom energy valve assembly 230, and the main pipe 240 are arranged.

The bracket 210 may have a thin plate shape or a plate shape. The bracket 210 may be placed on the outside of the construction machine 100. The bracket 210 may have a fastener (not shown) for fastening to the construction machine 100. The fastener (not shown) may be formed of, for example, a screw hole for insertion of a bolt thereinto or the like.

The main pipe 240 and the boom energy valve assembly 230 may be arranged on the front side of the bracket 210 facing the boom 130, the bracket 210 may have a hollow 212 formed on the rear side thereof, and the accumulator 220 may be placed between the front side and the rear side of the bracket 210. The bracket 210 may have a groove 213 formed on the front side thereof.

The groove 213 may be recessed rearwards from the front end of the bracket 210. The groove 213 may have a shape corresponding to the outer surface of the cabinet 150 of the construction machine 100, thereby minimizing spatial interference between the cabinet 150 and the bracket 210. The main pipe 240 and the boom energy valve assembly 230 may be arranged in an area of the front side of the bracket 210 where the groove 213 is not formed. In other words, the groove 213 may be formed on one area of the front side of the bracket 210, and the main pipe 240 and the boom energy valve assembly 230 may be arranged on the other area thereof.

The structure of this bracket 210 may allow the area of the bracket 210 where the main pipe 240 and the boom energy valve assembly 230 are arranged to be closer to the boom 130, thereby minimizing the length of various pipes or lines connected to the boom cylinder 140, resulting in minimal resistance against the flow of oil.

The hollow 212 may formed on the rear side of the bracket 210. The engine 120 may be placed on the rear side of the boom energy recovery unit 200. The hollow 212 may reduce the influence of heat generated by the engine 120 on the accumulator 220. The hollow 212 may also reduce the weight of the bracket 210. The hollow 212 may be formed on the rear side of the bracket 210, as well as at the center or on the front side of the bracket 210.

The accumulator 220 may be spaced apart from the rear end (end at the rear side) of the bracket 210. This makes it convenient to open the engine room to service the engine 120 and also easy for the operator to detach and install the accumulator 220, even when the boom energy recovery unit 200 is installed on the construction machine 100. Besides, it is possible to prevent direct transfer of the heat and vibration generated by the engine 120 to the accumulator 220.

The bracket 210 may have a mount 211 placed between the front side and the rear side thereof. The mount 211 is configured to mount the accumulator 220. The mount 211 may allow the accumulator 220 to be spaced apart from the upper surface of the bracket 210 by a predetermined distance. Accordingly, it is possible to facilitate the detachment and installation of the accumulator 220 and to prevent direct transfer of the heat and vibration generated by the engine 120 to the accumulator 220.

The bracket 210 may be detachably installed on the construction machine 100. The bracket 210 may be installed in a manner that renovates the exterior or interior of existing construction machinery. The specific size or detailed shape of the bracket 210 may be partially modified depending on the construction machine 100 to be installed. Owing to the configuration of this bracket 210, the boom energy and swing energy recovery system according to the present disclosure may be easily and conveniently installed in a variety of existing construction machines.

The accumulator 220 may be configured to accumulate oil, and the oil accumulated in advance in the accumulator 220 may be discharged from the accumulator 220 if necessary. The main pipe 240 is connected to the boom cylinder 140. The boom energy valve assembly 230 is connected to the main pipe 240.

The opening and closing of the boom energy valve assembly 230 may be individually adjusted by a pilot pipe 250. Specifically, the boom energy valve assembly 230 includes a first line L1, a second line L2, a third line L3, a first AC valve AC1, and a CA valve CA. The first line L1 is a line connected to the large chamber 142 in the boom cylinder 140. The first line L1 may be connected to the large chamber line 144. The second line L2 and the third line L3 are lines connecting the first line L1 and the accumulator 220.

The first AC valve AC1 is placed in the second line L2. The first AC valve AC1 may be a charging valve that is provided to enable the control of the flow of oil and to control oil to flow only toward the accumulator 220 in the second line L2 to charge the accumulator 220 with oil.

The CA valve CA is placed in the third line L3. The CA valve CA may be a discharge valve that is provided to enable the control of the flow of oil and to allow oil to flow only toward the first line L1 in the third line L3 to discharge the oil in the accumulator 220.

The boom energy valve assembly 230 may include a fourth line L4 connecting the accumulator 220 and the hydraulic motor 310. The boom energy valve assembly 230 may include a first CM valve CM1 provided to enable the control of the flow rate of oil in the fourth line L4. The first CM valve CM1 may be a motor discharge valve that allows oil to be discharged to the hydraulic motor 310 so as to rotate the hydraulic motor 310 by introducing the oil accumulated in the accumulator 220 into the hydraulic motor 310 through the fourth line L4.

The boom energy valve assembly 230 may include a fifth line L5 and a sixth line L6. The fifth line L5 is a line connected to the small chamber 143 in the boom cylinder 140. The fifth line L5 may be connected to the small chamber line 145. The sixth line L6 is a line that is branched from the first line L1 and connected to the fifth line L5. The sixth line L6 may be provided with an AB valve AB to enable the control of the flow rate of oil in the sixth line L6. The AB valve AB may be a regeneration valve that allows some of the oil flowing in the first line L1 to flow into the small chamber 143 in the boom cylinder 140 through the sixth line L6 and the fifth line L5.

The boom energy valve assembly 230 may include a seventh line L7. The seventh line L7 is a line that is branched from the first line L1 and connected to a third oil tank T3 to be described later. The seventh line L7 may be provided with an AR valve AR to enable the control of the flow rate of oil in the seventh line L7. The AR valve AR may be a return valve that is configured to allow the inflow of some of the oil flowing to the accumulator 220 if the accumulator 220 is full of oil.

The boom energy valve assembly 230 may further include an eighth line L8 connected to the fifth line L5 and the sixth line L6. The eighth line L8 may be connected to a fourth oil tank T4 to be described later. The oil that has passed through the AB valve AB may also flow into the fourth oil tank T4 through the eighth line L8. The eighth line L8 may be provided with a check valve (not shown).

The boom energy valve assembly 230 may include a first release valve RE1. The first release valve RE1 is placed on the passage between the accumulator 220 and a second oil tank T2 to be described later. The first release valve RE1 is operated in an on/off manner.

The boom energy valve assembly 230 may further include a first solenoid valve SOL1 connected in parallel to the first release valve RE1. Specifically, the first solenoid valve SOL1 may be connected to the front and rear ends of the first release valve RE1 via individual pipes, and may be placed in parallel to the first release valve RE1.

Thus, the first release valve RE1 and the first solenoid valve SOL1 may be installed in duplicate between the accumulator 220 and the second oil tank

T2.

The first CM valve CM1, CA valve CA, first AC valve AC1, AB valve AB, AR valve AR, first release valve RE1, first solenoid valve SOL1, etc. of the boom energy valve assembly 230 discussed above may all be controlled by the controller 170.

The main pipe 240 is a pipe connected to the boom cylinder 140. The main pipe 240 may be provided in a single one, and the first line L1 and the fifth line L5 may be formed together in the main pipe 240. Alternatively, the main pipe 240 may consist of two main pipes, and the first line L1 and the fifth line L5 may be formed separately in the respective main pipes. The main pipe 240 may be provided with a joint block 241 at the tip thereof. The large chamber 142 and the small chamber 143 in the boom cylinder 140 may be connected to the joint block 241.

The oil tank T may consist of one or more oil tanks to store oil introduced thereinto or to discharge the stored oil therefrom.

The oil tank T may include the first oil tank T1 connected to the hydraulic motor 310 of the hydraulic motor assembly 300 via a pipe, the second oil tank T2 connected to the first release valve RE1 and the first solenoid valve SOL1 via a pipe, the third oil tank T3 connected to the seventh line, and the fourth oil tank T4 connected to the eighth line.

The mobile device 400 may be a terminal held by a user or an operator.

The mobile device 400 may be communicatively connected to the controller 170. In addition, the mobile device 400 may be controllably connected to the controller 170, and the boom energy and swing energy recovery system for mobile-linked construction machinery may be controlled by the mobile device 400.

Specifically, the operations of the hydraulic motor assembly 300 and the boom energy recovery unit 200 may be controlled by the controller 170 based on the operation signal of the mobile device 400.

The mobile device 400 may include an input means to input a control command and an output means including a display means to display the statuses of operation of the hydraulic motor assembly 300 and the boom energy recovery unit 200.

Here, the mobile device 400 may be any one of a smartphone, a PDA, a laptop, and a tablet.

Moreover, the mobile device 400 may be configured to communicate with the controller 170 through serial communication or Ethernet communication or through Wi-Fi, Bluetooth, Zigbee, beacon, RFID, or the like, and the communication method of the mobile device 400 is not limited thereto.

For this purpose, the mobile device 400 may be equipped with a program or application for operating the boom energy and swing energy recovery system for mobile-linked construction machinery through the controller 170.

The controller 170 may control the operation of the construction machine 100 based on the operation signal. For this purpose, the controller 170 may be an electronic control unit (ECU).

Specifically, the controller 170 may control the operations of the hydraulic motor assembly 300 and the boom energy recovery unit 200 to operate the boom energy and swing energy recovery system, based on the operation signal from the control operation of the mobile device 400.

The controller 170 may control whether to open or close the boom-up valve 163 or the boom-down valve 164 based on the operation signal from the control operation of the mobile device 400.

In addition, the controller 170 may control the operation of the construction machine 100 and may control whether to open or close the boom-up valve 163 or the boom-down valve 164, based on the operation signal of the joystick 151.

For this purpose, the joystick 151 may be equipped with a first sensor S1 and a second sensor S2. The first sensor S1 may detect a change in pressure during boom-up motion by the joystick 151 to generate an operation signal, and the second sensor S2 may detect a change in pressure during boom-down motion by the joystick 151 to generate an operation signal.

The operation signals generated by the first sensor S1 and the second sensor S2 may be transmitted to the controller 170, and the controller 170 may control whether to open or close the boom-up valve 163 or the boom-down valve 164 based on these operation signals.

Here, the operation signals generated by the first sensor S1 and the second sensor S2 may be transmitted to the mobile device 400 through the controller 170. This may allow the mobile device 400 to control whether to open or close the boom-up valve 163 or the boom-down valve 164.

Meanwhile, the boom-down valve 164 may also be placed in the large chamber line 144. In other words, the boom-down valve 164 may control a flow in the boom-down valve line 166 as well as a flow in the large chamber line 144. In this case, in some situations, when the joystick 151 is operated for boom-down, the controller 170 may control the boom-down valve 164 to close, thereby blocking the flow of oil from the large chamber 142 to the main control valve 160. By means of the structure described above, a specific mode may be selected through the controller 170, and the controller 170 may control the operations of the hydraulic motor assembly 300 and the boom energy recovery unit 200, thereby operating the construction machine 100 in various modes.

Here, these various modes may be set, changed, and released by control of the controller 170 through the mobile device 400. In addition, these settings and de-settings may be performed by control of the controller 170 in response to the operation signal of the joystick 151.

Specifically, the controller 170 may cause the construction machine 100 to be operated in any one selected from a boom energy recovery mode, a boom energy eco mode, a boom energy power mode, a boom energy pressure release mode, and a boom-energy-recovery-off mode by the operation of the mobile device 400 or the joystick 151.

Here, the boom energy recovery mode is a basic setting mode that may be set together with the actuation of the construction machine 100, and may be set along with the general operation of the construction machine 100. In other words, the construction machine 100 may be set to the boom energy recovery mode immediately upon starting and then operated.

The boom energy recovery mode in which the boom energy and swing energy recovery system for mobile-linked construction machinery according to the embodiment of the present disclosure recovers energy will be described with reference to FIG. 7.

Specifically, the boom energy recovery mode is a mode in which potential boom energy in the event of boom-down is recovered to the accumulator 220 for storage, and the stored energy is then reused. The potential boom energy stored in the accumulator 220 during boom-down may be used when setting the boom energy eco mode and the boom energy power mode.

When the boom 130 is moved down, the boom-down valve 164 is closed, oil flows into the small chamber 143 in the boom cylinder 140 to lower the rod 141 of the boom cylinder 140, and the oil within the large chamber 142 is discharged through the first line L1 as the rod 141 is lowered.

The oil flowing in the first line L1 may be introduced into the accumulator 220 through the second line L2, and the oil introduced into the accumulator 220 may be accumulated and then utilized in the boom energy eco mode and in the boom energy power mode.

In this case, since the boom-down valve 164 is locked, oil may be discharged only to the first line L1 without flowing toward the main control valve 160.

This process may allow the potential boom energy of the boom 130 to be stored in the accumulator 220, and the stored potential boom energy may be utilized to save fuel or improve performance of the construction machine 100.

As another example, in the boom energy recovery mode, during boom-down, oil may flow into the accumulator 220 to store the potential boom energy of the boom 130 in the accumulator 220, while flowing into the small chamber 143 to increase a boom-down speed.

Specifically, when the boom 130 is moved down, the AB valve AB may be opened to introduce some of the oil flowing in the first line L1 into the small chamber 143 in the boom cylinder 140 through the sixth line L6 and the fifth line L5, while introducing the remainder of the oil flowing in the first line L1 into the accumulator 220 through the second line L2.

In this way, the boom-down speed of the boom 130 may be increased by the process of accumulating oil in the accumulator 220 and reintroducing oil into the small chamber 143 to rapidly lower the rod 141.

Here, the eighth line L8 may be further connected to the fifth line L5 and the sixth line L6. The eighth line L8 may be connected to the oil tank T, namely, the fourth oil tank T4. The oil that has passed through the AB valve AB may also flow into the fourth oil tank T4 through the eighth line L8.

As a further example, in the boom energy recovery mode, if the accumulator 220 is full of oil during boom-down, the oil introduced into the accumulator 220 may be diverted to the third oil tank T3 to facilitate the boom-down of the boom 130.

Specifically, if the accumulator 220 is full of oil during boom-down, the AR valve AR may be opened to introduce some of the oil flowing in the first line L1 into the third oil tank T3 through the seventh line L7.

As such, if the accumulator 220 is full of oil, the boom 130 may no longer be moved down, in which case the oil may be diverted to the third oil tank T3 to facilitate the boom-down of the boom 130.

Here, a fifth sensor S5 may be placed in front of the accumulator 220 in the second line L2. The fifth sensor S5 may measure a pressure in front of the accumulator 220. Thus, the fifth sensor S5 may measure whether the accumulator 220 is full of oil.

The boom energy eco mode is a mode in which the oil accumulated in the accumulator may be used to assist the output of the engine, thereby saving fuel. Referring to FIG. 8, the oil accumulated during boom-down may be used to assist the output of the engine during boom-up.

In the boom energy eco mode, when the boom 130 is moved up, the first CM valve CM1 placed in the fourth line L4 is opened, the CA valve CA placed in the third line L3 is closed, and the oil accumulated in the accumulator 220 then flows into the hydraulic motor 310 of the hydraulic motor assembly 300 through the fourth line L4.

The rotary shaft of the hydraulic motor 310 of the hydraulic motor assembly 300 is rotated by means of the oil introduced thereinto, and the rotational force of the rotary shaft of the hydraulic motor 310 is provided to the shaft 121 of the engine 120.

In the boom energy eco mode, the rotational force of the rotary shaft of the hydraulic motor 310 may assist the output of the shaft 121 of the engine 120, thereby increasing the fuel efficiency of the engine 120.

Meanwhile, the oil introduced into the hydraulic motor 310 may be discharged to the first oil tank T1 through the pipe again after rotating the rotary shaft of the hydraulic motor 310.

The boom energy power mode is a mode in which the power required for the boom-up motion of the boom is assisted by means of the oil accumulated in the accumulator. Referring to FIG. 9, the oil accumulated during boom-down may flow into the large chamber 142 to rapidly raise the rod 141.

In the boom energy power mode, when the boom 130 is moved up, the CA valve CA placed in the third line L3 is opened, the first CM valve CM1 placed in the fourth line L4 is closed, and the oil accumulated in the accumulator 220 then flows into the large chamber 142 through the third line L3 and the first line L1.

It is possible to increase the boom-up speed by increasing the amount of oil introduced into the large chamber 142, such as by introducing oil from the accumulator 220 to the large chamber 142 through the third line L3 and the first line L1, in addition to the inflow of oil to the large chamber 142 through the large chamber line 144 by the main pump 122 of the engine 120.

In the boom energy power mode, the AB valve AB, the AR valve AR, and the boom-down valve 164 may be closed, and only the CA valve CA placed in the third line L3 may be opened to introduce oil only into the large chamber 142 through the third line L3 and the first line L1 so as to assist the power required for boom-up motion.

The boom energy release mode is a mode in which the oil accumulated in the accumulator is discharged to the outside for pressure release. Referring to FIG. 10, the pressure release mode is adapted to reduce the internal pressure of the accumulator 220.

In the boom energy pressure release mode, the first release valve RE1 is opened, and the CA valve CA in the third line L3 and the first CM valve CM1 in the fourth line L4 are closed.

It is preferable that the first release valve RE1 be operated in an on/off manner and provided to only be simply opened or closed, rather than precisely adjusting the flow rate of oil, but the present disclosure is not limited thereto.

In this way, the first release valve RE1 may be opened to discharge some of the oil accumulated in the accumulator 220 to the second oil tank T2 through the pipe connecting the accumulator 220 and the second oil tank T2, thereby reducing the pressure within the accumulator 220.

For example, if the pressure of oil introduced into and accumulated in the accumulator 220 exceeds a preset pressure range, the first release valve RE1 may always be opened to introduce some of the oil introduced into the accumulator 220 into the second oil tank T2, thereby reducing the internal pressure of the accumulator 220.

Meanwhile, when it is intended to maintain the construction machine 100, the construction machine 100 may be set to the boom energy pressure release mode by allowing the first solenoid valve SOL1 to be opened to introduce all of the oil in the accumulator 220 into the second oil tank T2, and then maintained.

In this case, after the CA valve CA and the first CM valve CM1 are closed, only the first solenoid valve SOL1 is opened.

For example, when the construction machine 100 is in an idle state that is not in operation or when the construction machine 100, the hydraulic motor assembly 300, or the boom energy recovery unit 200 is intended to be serviced, it may be serviced after the first solenoid valve SOL1 is opened to introduce all of the oil in the accumulator 220 into the second oil tank T2 to release the internal pressure of the accumulator 220, thereby preventing safety accidents and so on.

As such, even when it is intended to maintain the construction machine, the pressure in the accumulator 220 may be released by opening the first release valve RE1 to introduce some of the oil flowing into the accumulator 220 into the second oil tank T2, or by opening the first solenoid valve SOL1 to introduce all of the oil flowing into the accumulator 220 into the second oil tank T2, or by opening both the first release valve RE1 and the first solenoid valve SOL1.

Here, the first solenoid valve SOL1 may be closed when the first release valve RE1 is opened, and similarly, the first release valve RE1 may be closed when the first solenoid valve SOL1 is opened.

In the boom-energy-recovery-off mode, an operation may be temporarily stopped in which potential boom energy generated in the event of boom-down is recovered to the accumulator.

In other words, referring to FIGS. 2 and 7, during the boom-down of the boom 130, the accumulation of oil in the accumulator 220 may be stopped if the boom 130 touches the ground and more force is required for the boom-down of the boom 130.

In this case, a third sensor S3 and a fourth sensor S4 may be placed in the first line L1 and the fifth line L5, respectively. The third sensor S3 and the fourth sensor S4 may constantly measure a hydraulic pressure and transmit measured values of hydraulic pressure to the controller 170.

The controller 170 may determine whether the boom 130 touches the ground based on these measured values.

Specifically, if the controller 170 determines that the boom 130 touches the ground, the first AC valve AC1 in the second line L2 connected to the accumulator 220 may be closed to temporarily stop the accumulation of oil in the accumulator 220.

In the boom-energy-recovery-off mode, if the controller 170 determines that the boom 130 touches the ground, both the first AC valve AC1 and the AR valve AR may be closed and the AB valve AB may be opened, so as to introduce the oil discharged from the large chamber 142 only into the small chamber 143 to temporarily stop the accumulation of oil in the accumulator 220.

In other words, the controller 170 may control the first AC valve AC1 placed in the second line L2 and the AR valve AR placed in the seventh line L7 to be closed and only the AB valve AB placed in the sixth line L6 to be opened, so as to introduce all of the oil discharged from the large chamber 142 into the small chamber 143.

Meanwhile, the swing energy recovery unit 500 may include a high-pressure accumulator 510, a swing energy valve assembly 530, a low-pressure accumulator 520, and an oil tank T, and may be installed by connection to the body 110, which is installed on the drive unit (not shown) of the construction machine 100 to swing horizontally by driving of a swing motor 501, and to any one main pump 122 of the engine 120.

Specifically, the high-pressure accumulator 510 may be connected to the main pump 122 of the engine 120 to accumulate oil introduced along with the rotation of the swing motor 501 and to discharge the accumulated oil to the hydraulic motor assembly 300 to assist the output of the engine 120.

The low-pressure accumulator 520 may be connected to the swing motor 501 connected to the main pump 122 of the engine 120 to provide oil to the swing motor 501, thereby preventing the cavitation of the swing motor 501.

The swing energy valve assembly 530 may include a plurality of lines for oil to flow therethrough, and at least one valve installed in at least one selected from the plurality of lines to control the flow rate of oil.

Specifically, the swing energy valve assembly 530 may include an eleventh line L11 having one side connected to the main pump 122, a twelfth line L12 connected to the other side of the eleventh line L11 and connected to the left side of the swing motor 501, a thirteenth line L13 connected to the other side of the eleventh line L11 and connected to the right side of the swing motor 501, a fourteenth line L14 branched from the twelfth line L12, a fifteenth line L15 branched from the thirteenth line L13, and a sixteenth line L16 that merges the fourteenth line L14 and the fifteenth line L15 and is connected to the high-pressure accumulator.

A direction switching valve 539 may be placed at the connection point between the eleventh line L11 and the twelfth and thirteenth lines L12 and L13 to control the direction of flow of oil, and the sixteenth line L16 may be provided with a second AC valve AC2 for controlling the flow rate of oil to allow oil to flow only toward the high-pressure accumulator 510.

The direction switching valve 539 may be connected and equipped with direction switching joysticks 503a and 503b for controlling the direction of flow of oil through the eleventh line L11 to the twelfth line L12 or the thirteenth line L13. The direction switching valve 539 may be controlled so that the oil introduced into the swing motor 501 through the eleventh line L11 is switched in direction to flow into the left side of the swing motor 501 through the twelfth line L12 connected to the left side of the swing motor 501 to rotate the swing motor 501 in the right direction, thereby swinging the body 110 in the right direction relative to the drive unit. On the other hand, the direction switching valve 539 may be controlled so that the oil introduced into the swing motor 501 through the eleventh line L11 is switched in direction to flow into the right side of the swing motor 501 through the thirteenth line L13 connected to the right side of the swing motor 501 to rotate the swing motor 501 in the left direction, thereby swinging the body in the left direction relative to the drive unit.

The swing energy valve assembly 530 may include a seventeenth line L17 connecting the high-pressure accumulator 510 and the hydraulic motor 310 of the hydraulic motor assembly 300. The seventeenth line L17 may be provided with a second CM valve CM2 for controlling the flow rate of oil.

Accordingly, the oil accumulated in the high-pressure accumulator 510 may flow into the hydraulic motor 310 through the seventeenth line L17. The second CM valve CM2 may be a discharge valve that allows oil to be discharged from the high-pressure accumulator 510 to the hydraulic motor 310 to rotate the hydraulic motor 310.

The swing energy valve assembly 530 may include a first check valve 531 and a second check valve 532 that are arranged in the fourteenth line L14 and the fifteenth line L15 to control the flow rate of oil. The fourteenth line L14 and the fifteenth line L15 may be provided with a sixth sensor S6 and a seventh sensor S7 that measure the pressure of the oil flowing in the fourteenth line L14 and the fifteenth line L15.

Accordingly, the controller 170 may selectively open and close the first and second check valves 531 and 532 depending on the pressure of the oil flowing in the fourteenth line L14 and the fifteenth line L15 through the sixth sensor S6 and the seventh sensor S7.

The sixteenth line L16 may be provided with an eighth sensor S8 that measures the pressure of the oil flowing in the sixteenth line L16. The second AC valve AC2 may be selectively opened and closed depending on the measured pressure of the oil.

The swing energy valve assembly 530 may include an eighteenth line L18 that is branched from the seventeenth line L17 and connected to a fifth oil tank T5 to be described later. The eighteenth line L18 may be provided with a second release valve RE2 that is operated in an on/off manner and placed between the high-pressure accumulator 510 and the fifth oil tank T5.

The eighteenth line L18 may also be provided with a second solenoid valve SOL2 placed in parallel to the second release valve RE2 between the high-pressure accumulator 510 and the fifth oil tank T5.

The swing energy valve assembly 530 may further include a twenty-first line L21 connecting the twelfth line L12 and the thirteenth line L13, and a twenty-second line L22 that is branched from the twenty-first line L21 and connected to the sixth oil tank T6.

The twenty-first line L21 may be provided with a first relief valve 537 and a second relief valve 538 that are spaced at regular intervals from each other and opened by the pressure of oil to control the flow rate of oil. The twenty-second line L22 may be provided with a fifth check valve 535.

When the swing of the body 110 is accelerated, a large amount of oil may be initially supplied to the swing motor 501.

Thus, if the pressure of the oil flowing into the twelfth line L12 or the thirteenth line L13 through the eleventh line L11 exceeds a preset oil pressure range, the first relief valve 537 or the second relief valve 538 may be automatically opened, and some of the oil flowing into the swing motor 501 through the twelfth line L12 or the thirteenth line L13 may be diverted to and introduced into the sixth oil tank T6 through the first or second relief valve 537 or 538 and the twenty-second line L22.

In addition, the first relief valve 537 and the second relief valve 538 may be opened and closed by the controller 170 if the preset oil pressure range is exceeded.

The swing energy valve assembly 530 may further include a twenty-third line L23 connecting the twelfth line L12 and the thirteenth line L13, and a twenty-fourth line L24 that is branched from the twenty-third line L23 and connected to the low-pressure accumulator 520.

The twenty-third line L23 may be provided with a third check valve 533 and a fourth check valve 534 that are spaced at regular intervals from each other to control the flow rate of oil.

When the swing of the body 110 is decelerated or stopped, the amount of oil supplied to the swing motor 501 needs to be reduced or stopped. In this case, the oil used to rotate the swing motor 501 flows to the high-pressure accumulator 510, but the swing motor 501 rotates without immediate deceleration or stop. Hence, if oil flows out after rotating the swing motor 501 and no additional oil is supplied to the swing motor 501 from the main pump 122, cavitation may occur in the swing motor 501.

Thus, when the swing of the body 110 is decelerated, the oil that flows into the swing motor 501 through the twelfth line L12 or the thirteenth line L13 to rotate the swing motor 501 and then flows out to the high-pressure accumulator 510 may be replaced, so that after the third check valve 533 or the fourth check valve 534 is opened, the oil in the low-pressure accumulator 520 is supplied to the swing motor 501 through the twenty-fourth line L24 and the third or fourth check valve 533 or 534, thereby preventing the cavitation of the swing motor 501.

The oil tank T may consist of one or more oil tanks to store oil introduced thereinto or to discharge the stored oil therefrom. Specifically, the oil tank T may include the fifth oil tank T5 connected to the eighteenth line L18 and the sixth oil tank T6 connected to the twenty-second line L22.

The controller 170 may control the swing energy recovery unit 500 to be operated, based on the operation signal of the mobile device 400 or the joystick 151, in any one selected from a swing energy recovery mode in which oil in the event of the swing of the body 110 is recovered to and then stored in the high-pressure accumulator, a swing energy eco mode in which the output of the engine 120 is assisted by means of the oil accumulated in the high-pressure accumulator 510, and a swing energy pressure release mode in which the oil accumulated in the high-pressure accumulator 510 is discharged to the outside to release the pressure within the high-pressure accumulator 510.

The swing energy recovery mode is a mode in which the operation of the swing energy recovery unit 500 is controlled so that oil in the event of the swing of the body 110 is recovered to the high-pressure accumulator 510 for storage, and the stored energy is then reused. The swing energy stored in the high-pressure accumulator 510 may be used in the swing energy eco mode.

In the swing energy recovery mode, when the body 110 swings, oil may flow into the swing motor 501 from the main pump 122, the swing motor 501 may be rotated by means of the oil introduced into the swing motor 501, and the oil used to rotate the swing motor 501 may be recovered to the high-pressure accumulator 510 for accumulation. The oil recovered to the high-pressure accumulator 510 may be accumulated, stored, and then utilized in the swing energy eco mode and so on.

Specifically, referring to FIG. 11, when the body 110 swings to the right, in the swing energy recovery mode, oil flows into the eleventh line L11 from the main pump 122, and the direction switching valve 539 is selectively controlled by the direction switching joysticks 503a and 503b to switch the direction of flow of oil to the twelfth line L12 for inflow of oil.

The swing motor 501 may be rotated in the right direction by means of the oil flowing into the twelfth line L12, so that the oil used to swing the body 110 in the right direction flows to the fourteenth line L14 through the thirteenth line L13, the oil flowing to the fourteenth line L14 is recovered to the high-pressure accumulator 510 through the sixteenth line L16, and the oil recovered to the high-pressure accumulator 510 is accumulated, stored, and then utilized.

On the other hand, referring to FIG. 12, when the body 110 swings to the left, in the swing energy recovery mode, oil flows into the eleventh line L11 from the main pump 122, and the direction switching valve 539 is selectively controlled by the direction switching joysticks 503a and 503b to switch the direction of flow of oil to the thirteenth line L13 for inflow of oil.

The swing motor 501 may be rotated in the left direction by means of the oil flowing into the thirteenth line L13, so that the oil used to swing the body 110 in the left direction flows to the fifteenth line L15 through the twelfth line L12, the oil flowing to the fifteenth line L15 is recovered to the high-pressure accumulator 510 through the sixteenth line L16, and the oil recovered to the high-pressure accumulator 510 is accumulated, stored, and then utilized.

Referring to FIG. 13, in the swing energy eco mode, when the body 110 swings, the second CM valve CM2 placed in the seventeenth line L17 is opened, and the oil accumulated in the high-pressure accumulator 510 flows into the hydraulic motor 310 of the hydraulic motor assembly 300 through the seventeenth line L17.

The rotary shaft of the hydraulic motor 310 may be rotated by means of the oil introduced into the hydraulic motor 310, and the rotational force of the rotary shaft may be provided to the shaft 121 of the engine 120 to assist the output of the shaft of the engine 120.

In the swing energy eco mode, the rotational force of the rotary shaft of the hydraulic motor 310 may assist the output of the shaft 121 of the engine 120, thereby increasing the fuel efficiency of the engine 120.

In this case, the oil introduced into the hydraulic motor 310 may be discharged to the first oil tank T1 through the pipe again after rotating the rotary shaft of the hydraulic motor 310.

Referring to FIG. 14, in the swing energy pressure release mode, the second release valve RE2 may be opened to discharge some of the oil accumulated in the high-pressure accumulator 510 to the fifth oil tank T5 through the second release valve RE2, thereby reducing the pressure within the high-pressure accumulator 510.

Additionally or alternatively, in the swing energy pressure release mode, the second solenoid valve SOL2 may be opened to discharge all of the oil accumulated in the high-pressure accumulator 510 to the fifth oil tank T5 through the second solenoid valve SOL2, thereby reducing the pressure within the high-pressure accumulator 510.

When the construction machine 100 is in an idle state that is not in operation or when the construction machine 100, the hydraulic motor assembly 300, or the swing energy recovery unit 500 is intended to be serviced, it may be serviced after the second release valve RE2 is opened to discharge some of the oil in the high-pressure accumulator 510 to the oil tank T to reduce the pressure within the high-pressure accumulator 510, or the second solenoid valve SOL2 is opened to discharge all of the oil in the high-pressure accumulator 510 to the oil tank T to release the internal pressure of the high-pressure accumulator 510, thereby preventing safety accidents and so on.

The flow process of oil during swing acceleration of the body 110 will be described below. Referring to FIG. 15, when the body 110 swings and the swing of the body 110 in the right direction is accelerated, oil flows into the eleventh line L11 from the main pump 122, and the direction switching valve 539 is selectively controlled by the direction switching joysticks 503a and 503b to switch the direction of flow of oil to the twelfth line L12 for inflow of oil.

If the pressure of the oil flowing into the twelfth line L12 exceeds a preset oil pressure range, the first relief valve 537 may be opened, and some of the oil introduced into the swing motor 501 through the twelfth line L12 may be diverted to and introduced into the sixth oil tank T6 through the first relief valve 537 and the twenty-second line L22.

In this case, the fifth check valve may be opened to introduce some of the oil flowing into the twenty-second line L22 into the oil tank T.

For example, if the pressure of oil flowing into the twelfth line L12 exceeds a preset reference pressure value of 280 bar and reaches 330 bar, the first relief valve 537 may be opened, some of the oil introduced into the swing motor 501 may be diverted to and introduced into the sixth oil tank T6 through the first relief valve 537 and the twenty-second line L22, and some of the remaining oil may be recovered to and accumulated in the high-pressure accumulator 510 after rotating the swing motor 501.

On the other hand, when the swing of the body 110 in the left direction is accelerated, oil flows into the eleventh line L11 from the main pump 122, and the direction switching valve 539 is selectively controlled by the direction switching joysticks 503a and 503b to switch the direction of flow of oil to the thirteenth line L13 for inflow of oil.

If the pressure of the oil flowing into the thirteenth line L13 exceeds a preset oil pressure range, the second relief valve 538 may be opened, and some of the oil introduced into the swing motor 501 through the thirteenth line L13 may be diverted to and introduced into the sixth oil tank T6 through the second relief valve 538 and the twenty-second line L22.

The flow process of oil during swing deceleration of the body 110 will be described below. Referring to FIG. 16, when the body 110 is decelerated or stopped and the swing of the body 110 in the right direction is decelerated or stopped, the oil that flows into the swing motor 501 through the twelfth line L12 to rotate the swing motor 501 in the right direction and then flows into to the high-pressure accumulator 510 is replaced, so that after the third check valve 533 is opened, the oil in the low-pressure accumulator 520 flows into the twenty-third line L23 through the twenty-fourth line L24 and the third check valve 533.

The oil flowing into the twenty-third line L23 may flow into the left side of the swing motor 501 through the twelfth line L12 to supply oil from the low-pressure accumulator 520 to the swing motor 501 rotated in the right direction, thereby preventing the cavitation of the swing motor 501.

On the other hand, when the swing of the body 110 in the left direction is decelerated or stopped, the oil that flows into the swing motor 501 through the thirteenth line L13 to rotate the swing motor 501 in the left direction and then flows into to the high-pressure accumulator 510 is replaced, so that after the fourth check valve 534 is opened, the oil in the low-pressure accumulator 520 flows into the twenty-third line L23 through the twenty-fourth line L24 and the fourth check valve 534.

The oil flowing into the twenty-third line L23 may flow into the right side of the swing motor 501 through the thirteenth line L13 to supply oil from the low-pressure accumulator 520 to the swing motor 501 rotated in the left direction, thereby preventing the cavitation of the swing motor 501.

While one or more exemplary embodiments have been described with reference to the accompanying drawings, it will be apparent to those skilled in the art that various variations and modifications may be made by adding, changing, or removing components without departing from the spirit and scope of the disclosure as defined in the appended claims, and these variations and modifications fall within the spirit and scope of the disclosure as defined in the appended claims.

1. A boom energy and swing energy recovery system for mobile-linked construction machinery, which is installed in a construction machine to recover energy, wherein the construction machine comprises a boom cylinder comprising a rod raised and lowered by means of a flow of oil, a large chamber, and a small chamber formed on the large chamber, an engine configured to provide the flow of oil to the boom cylinder and connected at its shaft to a main pump, a boom driven up/down by the boom cylinder by means of the flow of oil, and a body installed on a drive unit of the construction machine to swing horizontally by driving of a swing motor, the boom energy and swing energy recovery system comprising:
a main control valve connected to the boom cylinder to selectively control the flow of oil provided to the boom cylinder;
a hydraulic motor assembly comprising a hydraulic motor connected to the engine to generate a rotational force by means of oil introduced thereinto and connected at its rotary shaft to the shaft of the engine for provision of the rotational force, and at least one pipe for inflow and outflow of oil therethrough;
a boom energy recovery unit configured to recover oil wasted during boom-down by the boom cylinder;
a swing energy recovery unit configured to recover oil wasted during swing of the body;
a mobile device held by a user; and
a controller linked to the mobile device and configured to control an operation of the construction machine based on an operation signal,
wherein boom energy generated by means of the oil recovered by the boom energy recovery unit and swing energy generated by means of the oil recovered by the swing energy recovery unit are reused.

2. The boom energy and swing energy recovery system according to claim 1, wherein the main control valve comprises a spool operated to allow oil to flow toward the large chamber or the small chamber in the boom cylinder, a main valve line through which oil flows to the main control valve, a boom-up valve line connected to the spool and in which a boom-up valve is placed, the boom-up valve being opened so that oil flows to the large chamber by movement of the spool to allow the boom to be moved up, and a boom-down valve line connected to the spool and in which a boom-down valve is placed, the boom-down valve being opened so that oil flows to the small chamber by movement of the spool to allow the boom to be moved down.

3. The boom energy and swing energy recovery system according to claim 2, wherein the boom energy recovery unit comprises an accumulator connected to the boom cylinder to accumulate oil introduced from the boom cylinder and to discharge the accumulated oil to the boom cylinder and the engine, a boom energy valve assembly comprising a plurality of lines for oil to flow therethrough and at least one valve installed in a selected one of the plurality of lines to control a flow rate of oil, and at least one oil tank provided to store oil introduced thereinto or discharge the stored oil therefrom.

4. The boom energy and swing energy recovery system according to claim 3, wherein the boom energy valve assembly further comprises:
a first line having one side connected to the large chamber in the boom cylinder, a second line connecting the first line and the accumulator, a third line connecting the first line and the accumulator, a fourth line connecting the accumulator and the hydraulic motor assembly, a fifth line having one side connected to the small chamber in the boom cylinder, a sixth line branched from the first line and connected to the fifth line, a seventh line branched from the first line, and an eighth line having one side connected to the fifth line and the sixth line; and
a first AC valve placed in the second line to control the flow rate of oil to allow oil to flow only toward the accumulator, a CA valve placed in the third line to control the flow rate of oil to allow oil to flow only toward the first line, a first CM valve placed in the fourth line to control the flow rate of oil, an AB valve placed in the sixth line to control the flow rate of oil, an AR valve placed in the seventh line to control the flow rate of oil, a first release valve placed on a passage between the accumulator and the oil tank and operated in an on/off manner, and a first solenoid valve placed in parallel to the first release valve between the accumulator and the oil tank.

5. The boom energy and swing energy recovery system according to claim 4, wherein the controller controls the boom energy recovery unit to be operated, based on the operation signal, in any one selected from a boom energy recovery mode in which oil in the event of boom-down of the boom is recovered to the accumulator for storage, a boom energy eco mode in which an output of the engine is assisted by means of the oil accumulated in the accumulator, a boom energy power mode in which the oil accumulated in the accumulator is used to assist the power required for boom-up motion, a boom energy pressure release mode in which the oil accumulated in the accumulator is discharged to the outside to release a pressure within the accumulator, and a boom-energy-recovery-off mode in which accumulation is temporarily stopped when the boom touches the ground.

6. The boom energy and swing energy recovery system according to claim 5, wherein in the boom energy recovery mode, when the boom is moved down,
after the boom-down valve is closed, oil flows into the small chamber in the boom cylinder to lower the rod of the boom cylinder,
the oil within the large chamber is discharged through the first line,
the oil flowing in the first line is recovered to the accumulator through the second line, and
the oil recovered to the accumulator is accumulated, stored, and then utilized.

7-8. (canceled)

9. The boom energy and swing energy recovery system according to claim 5, wherein in the boom energy eco mode, when the boom is moved up,
the first CM valve placed in the fourth line is opened, the CA valve placed in the third line is closed,
the oil accumulated in the accumulator flows into the hydraulic motor of the hydraulic motor assembly through the fourth line,
the rotary shaft of the hydraulic motor is rotated by means of the oil introduced thereinto, and
the rotational force of the rotary shaft of the hydraulic motor is provided to the shaft of the engine to assist the output of the shaft of the engine.

10. The boom energy and swing energy recovery system according to claim 5, wherein in the boom energy power mode, when the boom is moved up,
the CA valve placed in the third line is opened, the first CM valve placed in the fourth line is closed,
the oil accumulated in the accumulator flows into the large chamber in the boom cylinder through the third line and the first line, and
the boom has an increased boom-up speed by introducing oil from the accumulator to the large chamber to increase an amount of oil introduced into the large chamber, in addition to the inflow of oil to the large chamber by the engine.

11. The boom energy and swing energy recovery system according to claim 5, wherein in the boom energy pressure release mode,
the first release valve is opened, the CA valve and the first CM valve are closed, and
some of the oil accumulated in the accumulator is discharged to the oil tank through the first release valve to reduce the pressure within the accumulator.

12. (canceled)

13. The boom energy and swing energy recovery system according to claim 5, wherein in the boom-energy-recovery-off mode, when the boom touches the ground, the first AC valve is closed to temporarily stop accumulation of oil in the accumulator.

14. (canceled)

15. The boom energy and swing energy recovery system according to claim 1, wherein the swing energy recovery unit comprises a high-pressure accumulator connected to a swing motor connected to the main pump of the engine to accumulate oil introduced along with rotation of the swing motor and to discharge the accumulated oil to the hydraulic motor assembly, a low-pressure accumulator connected to the swing motor connected to the main pump of the engine to provide oil to the swing motor, thereby preventing cavitation of the swing motor, a swing energy valve assembly comprising a plurality of lines for oil to flow therethrough and at least one valve installed in a selected one of the plurality of lines to control a flow rate of oil, and at least one oil tank provided to store oil introduced thereinto or discharge the stored oil therefrom.

16. The boom energy and swing energy recovery system according to claim 15, wherein the swing energy valve assembly further comprises:
an eleventh line having one side connected to the main pump, a twelfth line connected to the other side of the eleventh line and connected to the left side of the swing motor, a thirteenth line connected to the other side of the eleventh line and connected to the right side of the swing motor, a fourteenth line branched from the twelfth line, a fifteenth line branched from the thirteenth line, a sixteenth line merging the fourteenth line and the fifteenth line and connected to the high-pressure accumulator, a seventeenth line connecting the high-pressure accumulator and the hydraulic motor, and an eighteenth line branched from the seventeenth line and connected to the oil tank; and
a direction switching valve placed at a connection point between the eleventh line and the twelfth and thirteenth lines to control a direction of flow of oil, a second AC valve placed in the sixteenth line to control the flow rate of oil to allow oil to flow only toward the high-pressure accumulator, a second CM valve placed in the seventeenth line to control the flow rate of oil, first and second check valves arranged in the fourteenth line and the fifteenth line to control the flow rate of oil, a second release valve placed between the high-pressure accumulator and the oil tank in the eighteenth line and operated in an on/off manner, and a second solenoid valve placed in parallel to the second release valve between the high-pressure accumulator and the oil tank in the eighteenth line.

17. The boom energy and swing energy recovery system according to claim 16, wherein the controller controls the swing energy recovery unit to be operated, based on the operation signal, in any one selected from a swing energy recovery mode in which oil in the event of swing of the body is recovered to and then stored in the high-pressure accumulator, a swing energy eco mode in which an output of the engine is assisted by means of the oil accumulated in the high-pressure accumulator, and a swing energy pressure release mode in which the oil accumulated in the high-pressure accumulator is discharged to the outside to release a pressure within the high-pressure accumulator.

18. The boom energy and swing energy recovery system according to claim 17, wherein in the swing energy recovery mode, when the body swings,
oil flows into the eleventh line from the main pump,
the direction switching valve is controlled to switch the direction of flow of oil to the twelfth line or the thirteenth line for inflow of oil,
the oil flowing into the twelfth line or the thirteenth line allows the swing motor to be rotated in a right or left direction, and then flows into the fourteenth line or the fifteenth line through the thirteenth line or the twelfth line,
the oil flowing into the fourteenth line or the fifteenth line is recovered to the high-pressure accumulator through the sixteenth line, and
the oil recovered to the high-pressure accumulator is accumulated, stored, and then utilized.

19. The boom energy and swing energy recovery system according to claim 17, wherein in the swing energy eco mode, when the body swings,
the second CM valve placed in the seventeenth line is opened,
the oil accumulated in the high-pressure accumulator flows into the hydraulic motor of the hydraulic motor assembly through the seventeenth line,
the rotary shaft of the hydraulic motor is rotated by means of the oil introduced thereinto, and
the rotational force of the rotary shaft is provided to the shaft of the engine to assist the output of the shaft of the engine.

20. The boom energy and swing energy recovery system according to claim 17, wherein in the swing energy pressure release mode, the second release valve is opened to discharge some of the oil accumulated in the high-pressure accumulator to the oil tank through the second release valve, thereby reducing the pressure within the high-pressure accumulator.

21. (canceled)

22. The boom energy and swing energy recovery system according to claim 16, wherein the swing energy valve assembly further comprises:
a twenty-first line connecting the twelfth line and the thirteenth line, and a twenty-second line branched from the twenty-first line and connected to the oil tank; and
first and second relief valves spaced at regular intervals from each other in the twenty-first line and opened by the pressure of oil to control the flow rate of oil, and a fifth check valve placed in the twenty-second line to control the flow rate of oil.

23. The boom energy and swing energy recovery system according to claim 22, wherein, when the pressure of the oil flowing into the twelfth line or the thirteenth line through the eleventh line during swing acceleration of the body exceeds a preset oil pressure range, the controller causes:
the first relief valve or the second relief valve to be opened;
some of the oil introduced into the swing motor through the twelfth line or the thirteenth line to flow into the twenty-second line through the twenty-first line and the first relief valve or the twenty-first line and the second relief valve; and
the fifth check valve to be opened to introduce some of the oil flowing into the twenty-second line into the oil tank.

24. The boom energy and swing energy recovery system according to claim 16, wherein the swing energy valve assembly further comprises:
a twenty-third line connecting the twelfth line and the thirteenth line, and a twenty-fourth line branched from the twenty-third line and connected to the low-pressure accumulator; and
third and fourth check valves spaced at regular intervals from each other in the twenty-third line and configured to control the flow rate of oil.

25. The boom energy and swing energy recovery system according to claim 24, wherein, when the swing of the body is decelerated, the controller causes:
the oil that flows into the swing motor through the twelfth line or the thirteenth line to rotate the swing motor and then flows into the high-pressure accumulator to be replaced,
so that after the third or fourth check valve is opened, the oil in the low-pressure accumulator flows into the twenty-third line through the twenty-fourth line and the third or fourth check valve; and
the oil flowing into the twenty-third line to be introduced into the swing motor through the twelfth line or the thirteenth line, thereby preventing the cavitation of the swing motor.
